(19) United States
(12) Patent Application Publication
(10) Pub. No.: US 2011/0070883 A1
(43) Pub. Date: Mar. 24, 2011

(54) System and Method for Automatic Carrier Change Detection in a Wireless Communications System

(75) Inventors: Hailong Wang, Shenzhen (CN); Thawatt Gopal, San Diego, CA (US); Binsong Tang, Shenzhen (CN)

(73) Assignee: FUTUREWEI TECHNOLOGIES, INC., Plano, TX (US)

(21) Appl. No.: 12/885,447

(22) Filed: Sep. 18, 2010

Related U.S. Application Data
(60) Provisional application No. 61/245,589, filed on Sep. 24, 2009.

(51) Int. Cl. H04W 24/00

(52) U.S. Cl. 455/424

(57) ABSTRACT

A system and method for automatic carrier change detection in a wireless communications system are provided. A method for centralized carrier change detection includes detecting a carrier change in a carrier deployment of a cell, determining at least one inter-frequency neighbor cells of the cell, and updating the at least one inter-frequency neighbor cells regarding the carrier change.

This application claims the benefit of U.S. Provisional Application No. 61/245,589, filed Sep. 24, 2009, entitled “System and Method for Automatic Carrier Growth Detection in a Wireless Communications System,” which application is hereby incorporated herein by reference.

### TECHNICAL FIELD

The present invention relates generally to wireless communications, and more particularly to a system and method for automatic carrier change detection in a wireless communications system.

### BACKGROUND

Carrier growth may be required when an operator of a communications system has determined that the communications system has reached a supported capacity on one or more deployed carriers and there is a need to support increased capacity by adding additional carriers. Similarly, carrier reduction may be required when the operator determines that the communications system has dropped below a specified usage level and one or more deployed carrier may be dropped to reduce operating costs.

In general, changes to deployed carriers (either increasing or decreasing the number of deployed carriers) of a cell, herein referred to as a center cell, in a communications system typically will involve human (e.g., the operator) interaction to manually configure information in cells that neighbor the center cell. Therefore, changes to deployed carriers may be a time consuming and potentially error prone operation. Hence, the operator may be hesitant to make changes to the deployed carriers, thereby leading to an overloaded communications system when there is a need to add additional carriers or an underutilized communications system when there are deployed carriers that are not being used to their capacity.

However, as communications systems continue to become more complex, there is a drive to automate the management of the communications systems as much as possible. As an example, with the Third Generation Partnership Project (3GPP) Long Term Evolution (LTE) compliant communications systems, self-organizing networks (SON) may be seen as a way for operators to reduce operational expenditures.

Interest in SON may be driven by several factors, including a large and complex number and structure of communications parameters, parallel operation of multi-generational infrastructures, and rapid growth in number of base stations (also referred to as NodeBs, enhanced NodeBs (eNB), cells, communications controllers, and so forth). SON has as its aim to automatically configure and optimize a communications system so that human interaction is minimized.

SON may have multiple functionality goals, including self-configuration, self-optimization, and self-healing. Self-configuration involves automatic installation of newly deployed nodes, such as eNBs. Self-optimization involves the use of measurements made by communications devices, such as eNBs, mobile stations (also referred to as terminals, users, user equipment (UE), communications device, and so on), to tune the operation of the communications system. Self-healing involves the detection and localization of failures and the application of self-healing mechanisms to solve the failures.

Therefore, there is a need to automate carrier change procedures in a communications system.

### SUMMARY OF THE INVENTION

These and other problems are generally solved or circumvented, and technical advantages are generally achieved, by preferred embodiments of the present invention which automatic carrier change detection in a wireless communications system.

In accordance with a preferred embodiment of the present invention, a method for centralized carrier change detection is provided. The method includes detecting a carrier change in a carrier deployment of a cell, determining at least one inter-frequency neighbor cell of the cell, and updating the at least one inter-frequency neighbor cell regarding the carrier change.

In accordance with another preferred embodiment of the present invention, a method for communications controller operation is provided. The method includes receiving an update regarding a change in a carrier deployment of a cell, instructing a served communications device to perform an inter-frequency neighbor measurement, and updating an inter-frequency neighbor cell list.

In accordance with another preferred embodiment of the present invention, a method for carrier change detection in a cell is provided. The method includes detecting a carrier change in a carrier deployment of the cell, determining at least one intra-frequency neighbor cell of the cell, and updating the at least one intra-frequency neighbor cell regarding the carrier change.

In accordance with another preferred embodiment of the present invention, a network entity is provided. The network entity includes a carrier change detect unit, an inter-frequency neighbor cell determine unit coupled to the carrier change detect unit, a messaging unit coupled to the carrier change detect unit and to the inter-frequency neighbor cell determine unit, and a transmitter coupled to the messaging unit. The inter-frequency neighbor cell determine unit detects a change in a carrier deployment of a cell managed by the manager, the inter-frequency neighbor cell determine unit determines inter-frequency neighbor cells of the cell, the messaging unit generates an update message, and the transmitter sends the update message.

An advantage of an embodiment is that changes to deployed carriers of a center cell may automatically lead to changes in configuration information of neighboring cells. Thereby eliminating error prone manual configuration information changes and propagation, which may negatively impact performance.

A further advantage of an embodiment is that automated configuration information changes and propagation may simplify implementation of deployed carriers of a center cell. Therefore, deployed carriers of the center cell may be changed more often to meet changing traffic patterns. For example, the number of deployed carriers may be changed to meet daily traffic patterns.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a diagram of a communications system;

FIG. 2 is a illustrates a communications system, wherein an EMS based automatic carrier change detection technique for inter-frequency automatic neighbor relationship (ANR) is used;

FIG. 3a is a flow diagram of EMS operations in an EMS-based automatic carrier growth detection technique;

FIG. 3b is a flow diagram of neighbor cell operations in an EMS-based automatic carrier growth detection technique;

FIG. 4 is a diagram of a communications system;

FIG. 5 is a diagram of a communications system, wherein a cell-based automatic carrier growth detection technique for inter-frequency ANR is used;

FIG. 6a is a flow diagram of center cell operations in a cell-based automatic carrier growth detection technique;

FIG. 6b is a flow diagram of neighbor cell operations in a cell-based automatic carrier growth detection technique;

FIG. 7 is a diagram of an alternate illustration of an EMS; and

FIG. 8 is a diagram of an alternate illustration of a cell.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a 3GPP LTE compliant communications system that support changes in deployed carriers. The invention may also be applied, however, to other communications systems that allow changes to be made in deployed carriers, such as WiMAX, and so on.

The embodiments discussed herein may facilitate an automatic detecting of carrier change in a cell of an LTE compliant communications system by its neighbor cells so that its neighbor cells will automatically perform relevant air-interface measurements to detect their respective neighbor relationship tables (NRT). NRTs may contain information about both intra-frequency neighbor cells and inter-frequency neighbor cells. The air-interface measurements are part of the LTE inter-frequency automatic neighbor relationship (ANR) function that enables the automatic detection and configuration of inter-frequency LTE cells in the surrounding neighboring cells. Without automatic carrier growth detection, the operator of the wireless communications system would need to manually configure the surrounding neighbors with the new carrier information.

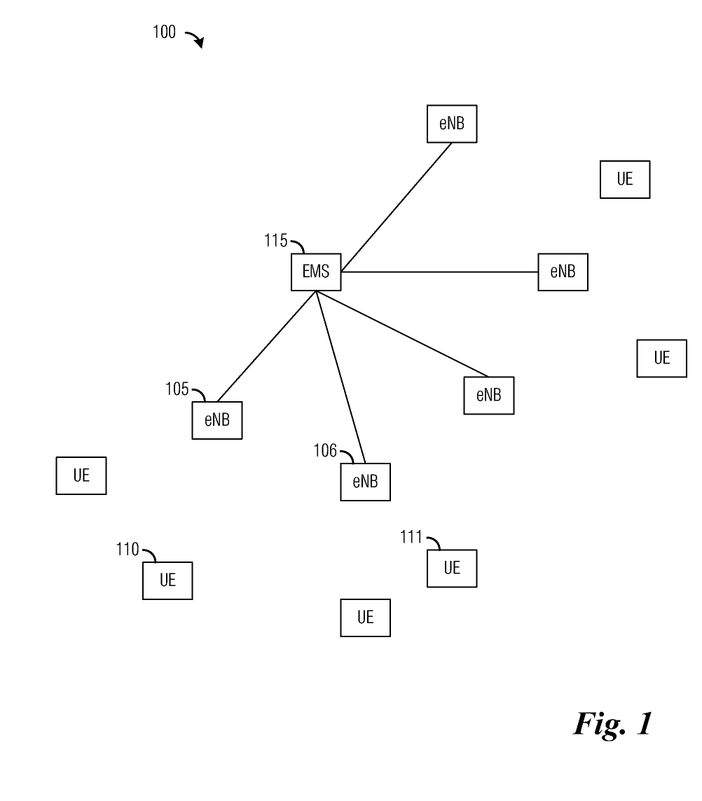

FIG. 1 illustrates a communications system 100. Communications system 100 includes a plurality of eNBs, such as eNB 105 and eNB 106. Each eNB may serve a number of UEs. For example, eNB 105 may serve UE 110 among other UEs, while eNB 106 may serve UE 111. An eNB may control transmissions to a UE as well as transmissions from a UE.

An element management system (EMS) 115 (a network entity) may be coupled to the eNBs in communications system 100 and may be used to manage the eNBs. EMS 115 may be used to configure the eNBs, change/update configuration information in the eNBs, add/remove deployed carriers, determine neighboring cells of an eNB, and so forth. EMS 115 may be connected to the eNBs over a wireline or wirelessly.

Automatic carrier change detection may occur in a centralized manner or a distributed manner. With centralized automatic carrier change detection, an EMS may control the updating of configuration information and inter-frequency neighbor lists, while with distributed automatic carrier change detection, the cells (specifically, the cells where the carrier change takes place, i.e., center cells) may control the updating of configuration information and inter-frequency neighbor lists. One or both techniques may be implemented in a communications system and whichever is used may be based on factors such as EMS load, cell load, and so forth.

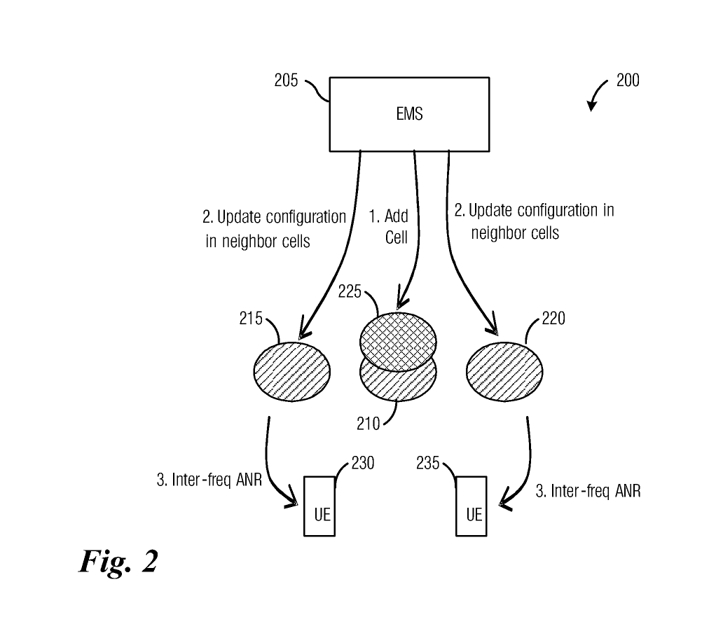

FIG. 2 illustrates a communications system 200, wherein an EMS based automatic carrier change detection technique for inter-frequency automatic neighbor relationship (ANR) is used. Communications system 200 includes an EMS 205 that may include systems and applications that may be used to manage network elements of communications system 200. EMS 205 may be used to manage eNBs, such as eNBs 210, 215, and 220. Communications system 200 also includes UE, such as UE 230, and 235. The eNBs may serve the UEs by scheduling transmissions to and from the UEs using available network resources.

As shown in FIG. 2, a supported capacity of eNB 210 may be reached (or exceeded) and to provide acceptable performance, additional carrier(s) (such as carrier 225) may be added to eNB 210. EMS 205 may be used to enable the automatic carrier growth detection.

EMS-based automatic carrier growth detection may include the following operations:

1. An operator (through EMS 205) may add one or more carriers to eNB 210, i.e., center cell. Configuration of the new carrier(s) may be performed manually or automatically through the use of scripts executing on an operations support system (OSS) platform at EMS 205.

2. As the new carrier(s) are added to eNB 210 (center cell), EMS 205 using an EMS internal algorithm may determine possible neighboring cells of the new carrier(s). EMS 205 may use techniques that make use of geo-location information, antenna azimuth angle, tilt, and so forth, to determine the possible neighboring cells. A detailed description of the determining of possible neighbor cells is provided below. EMS 205 may then automatically configure the new carrier(s) information (e.g., frequency) for the possible neighboring cells. The automatic configuration performed by EMS 205 may cause a configuration update to be sent to the possible neighboring cells.

3. The configuration update from EMS 205 may be used by the possible neighboring cells to configure measurement command messages (for example, radio resource control (RRC) signaling messages) to instruct UEs, such as UEs 230 and 235, to perform an inter-frequency neighbor measurement. The inter-frequency measurements may be described in detail in 3GPP TS36.300 and 3GPP TS36.331 technical specifications, which are incorporated herein by reference. The possible neighboring cells may start to instruct the UEs to scan the new frequency (of the new carrier(s)) and correspondingly automatically add the new carrier(s) to their inter-frequency neighbor cell list through the use of inter-frequency ANR procedures. The inter-frequency ANR procedures may be described in detail in 3GPP TS36.300 and 3GPP TS36.331 technical specifications.

Although the discussion of the above described EMS-based automatic carrier growth detection technique focuses on adding carriers, the EMS-based automatic carrier growth detection technique may also be applied to removing carriers. For example, in a communications system, during business hours, a center cell (e.g., located at an air port or a shopping mall) may have a heavy traffic load and carriers may need to be added. However, at night, the center cell may have a light traffic load and carriers may be removed to help reduce operating costs. The EMS-based automatic carrier growth detection technique described above may be used in both situations. Therefore, the discussion of carrier growth should not be construed as being limiting to either the scope or the spirit of the embodiments.

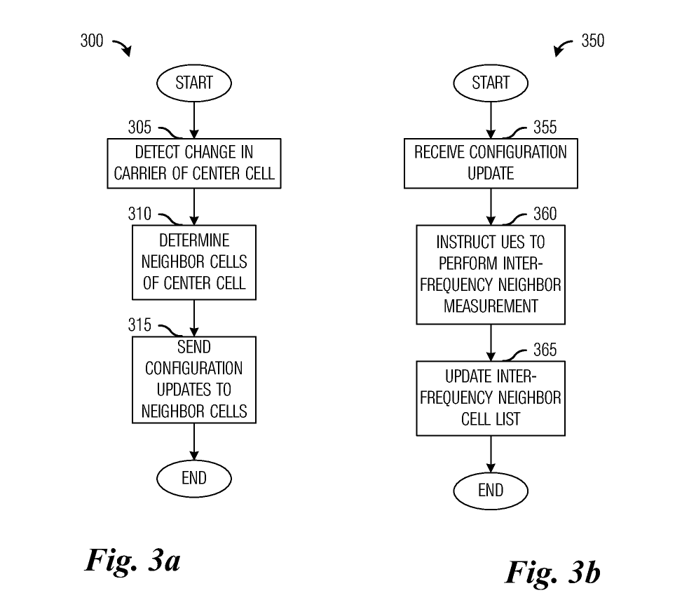

FIG. 3a illustrates a flow diagram of EMS operations 300 in an EMS-based automatic carrier growth detection technique. EMS operations 300 may be indicative of operations occurring in an EMS as the EMS participates in the EMS-based automatic carrier growth detection technique discussed previously. EMS operations 300 may occur whenever a carrier(s) is added to or removed from a center cell. EMS operations 300 may occur while the EMS is in a normal operating mode.

EMS operations 300 may begin after a carrier(s) has been added to or removed from a center cell. The change in the carrier may have been made manually by an operator of the communications system or automatically due to network conditions, time of day, specified day, or so forth. Configuration of the carrier change may be performed manually (by the operator, for example) or automatically (by executing scripts, for example). According to an embodiment, both manual and automatic carrier change may be performed via the EMS. The EMS may detect the change in carrier of the center cell (block 305). As an example, the EMS may detect that the operator has changed the carrier configuration of the center cell or a script for changing the carrier configuration has been executed.

The EMS may generate a configuration update regarding the center cell with respect to the carrier change. The configuration update may be sent to cells that are neighbors (referred to as neighbor cells) of the center cell.

The EMS may then determine the neighbor cells of the center cell (block 310). If a carrier(s) is added to the center cell, then the EMS may determine the inter-frequency neighbor cells of the center cell, i.e., neighbor cells of the center cell with respect to the new carrier(s). If a carrier(s) is removed from the center cell, then the EMS may already know the impact of the removal of the carrier(s) on the neighbor cells of the center cell, for example, the center cell will not be able to perform a handoff on the removed carrier(s), and may adjust the neighbor cell information accordingly. The EMS may determine the neighbor cells of the center cell based on information pertaining to the center cell, such as the center cell's geo-location information, antenna configuration (such as antenna azimuth angle, tilt, array configuration, and so forth), and so on. The information pertaining to the center cell may be stored in a database stored in the EMS or accessible by the EMS.

According to an embodiment, the EMS may determine the inter-frequency neighbor cells based on a NRT of the center cell if the NRT is stable, i.e., if the ANR function has been active for some time and contents of the neighbor list is stable. For example, an intra-frequency NRT may be used to determine the neighbor cells for the center cell's new carrier(s). Due to differences in propagation characteristics of signals at different frequencies, if frequency differences between the carriers are small, then inferring inter-frequency neighbor cells from the intra-frequency NRT may provide good results. However, if the frequency differences are large, the coverage, and hence neighbor cells, for the intra-frequency center cell and the inter-frequency center cell may not be the same and inferring inter-frequency neighbor cells from the intra-frequency neighbor cells may not provide good results.

For example, let a cell's carrier deployment include a first carrier with operating frequency F1 and a second (and newly added) carrier with operating frequency F2. If the F1 and F2 are similar (e.g., a difference between F1 and F2 within 100 MHz or so), then the coverage of the two carriers are almost similar and the neighbor cells of the first carrier and the second carriers are about the same. If F2 is smaller than F1, the coverage area of the second carrier is larger than the coverage area of the first carrier. Therefore, the neighbor cells of the first carrier are a subset of potential neighbor cells for the second carrier. Similarly, if F2 is larger than F1, the coverage area of the second carrier is smaller than the coverage area of the first carrier. Hence, the potential neighbor cells of the second carrier are a subset of the neighbor cells of the first carrier. It may then be possible in the situation where F2 is larger than F1 to use a distance based technique to determine the potential neighbor cells of the second carrier that takes a subset of the first carrier's neighbor cells as potential neighbor cells for the second carrier.

According to another embodiment, the EMS may use geo-location calculation(s) to determine a potential list of inter-frequency neighbor cells. For example, the EMS may use the center cell's latitude and longitude information along with its antenna bearing and a distance factor to compute the potential list of inter-frequency neighbor cells. For example, the EMS may select cells that are within a distance range from the center cell as inter-frequency neighbor cells.

According to another embodiment, the EMS may select cells that are within a specified distance from the center cell as inter-frequency neighbor cells, where the specified distance may be determined based on the center cell's cell morphology, radio frequency (RF) propagation characteristics, operating frequency, field test measurements, and so forth.

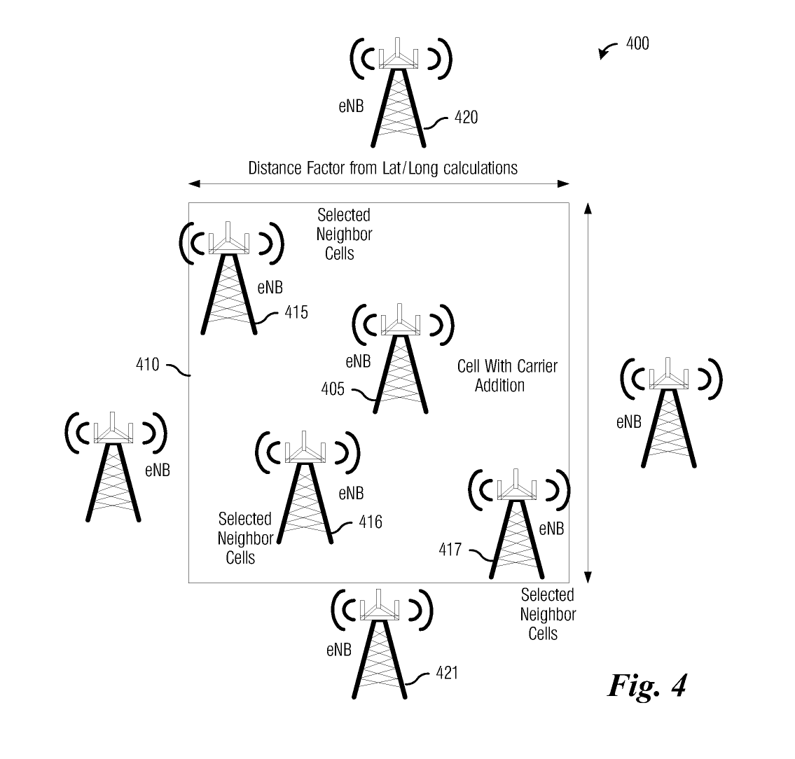

FIG. 4 illustrates a communications system 400. As shown in FIG. 4, communications system 400 has experienced carrier change in an eNB and an EMS-based carrier growth detection technique is used. Communications system 400 includes an eNB 405 (i.e., center cell) that has had the addition of a new carrier to help meet increased bandwidth requirements. Communications system 400 includes an EMS (not shown) that may be used to determine which neighboring cells to send configuration update messages with details regarding the new carrier addition to. Several different techniques may be used to determine the neighboring cells of an eNB, such as eNB 405.

As shown in FIG. 4, the EMS may use geo-location information, such as the longitude and latitude information of eNB 405 (the eNB with the carrier addition), along with a distance factor, the EMS may compute a potential list of cells that fall within a specified distance from eNB 405. A region covering the specified distance from eNB 405 is shown as box 410 drawn about eNB 405. eNBs within box 410 (such as eNBs 415, 416, and 417) may be within the specified distance from eNB 405 and may be selected as inter-frequency neighbor cells and to receive configuration update messages from the EMS with the additional carrier information. While eNBs outside box 410 (such as eNBs 420 and 421) may not be selected as inter-frequency nor to receive the configuration update messages from the EMS. The distance factor may be estimated based on cell morphology, RF propagation characteristics, operating frequency, field test measurements, and so forth.

Referencing back to FIG. 3a, after determining the inter-frequency neighbor cells of the center cell, the EMS may send the configuration update to the inter-frequency neighbor cells (block 315). According to an embodiment, the EMS may send the configuration update to the inter-frequency neighbor cells using an operations, administration, and management (OAM) system. After sending the configuration update to the inter-frequency neighbor cells, EMS operations 300 may then terminate.

FIG. 3b illustrates a flow diagram of neighbor cell operations 350 in an EMS-based automatic carrier growth detection technique. Neighbor cell operations 350 may be indicative of operations occurring in a cell that is an inter-frequency neighbor (i.e., an inter-frequency neighbor cell) to a center cell that has had a change (increase or decrease) in its carrier deployment as the neighbor cell participates in the EMS-based automatic carrier growth detection technique discussed previously. Neighbor cell operations 350 may occur while the neighbor cell is in a normal operating mode.

Neighbor cell operations 350 may begin with the neighbor cell receiving a configuration update from the EMS (block 355). According to an embodiment, the configuration update may be sent by the EMS to cells that have been determined to be inter-frequency neighboring cells of the center cell that has had the carrier change. For example, the EMS may determine neighboring cells based on an NRT, geo-location calculations, cells within a specified distance from the center cell, or so on. The configuration update may be transmitted to the neighbor cells using high level messages, such as OAM signaling.

The neighbor cell may instruct UEs that it is serving to perform inter-frequency neighbor measurements (block 360). According to an embodiment, the neighbor cell may send a configure measurement command measurements message, e.g., RRC messages, to instruct the UEs that it is serving to scan the new carrier if the cell has added additional carrier(s). The neighbor cell may also add new cell(s) to its inter-frequency neighbor cell list through the use of inter-frequency ANR procedures involving the UEs. Additionally, if the center cell has removed one or more deployed carriers, then the neighbor cell may not need to instruct the UEs to perform inter-frequency neighbor measurements, since the center cell may know to not allow a handoff to a neighbor cell on a non-existent carrier.

As part of the inter-frequency ANR procedures, the neighbor cell may receive reports back from the UEs and the neighbor cell may make use of the reports from the UEs to update its inter-frequency neighbor cell list (block 365). Updates to the neighbor cell's inter-frequency neighbor cell list may propagate back to the EMS. Neighbor cell operations 350 may then terminate.

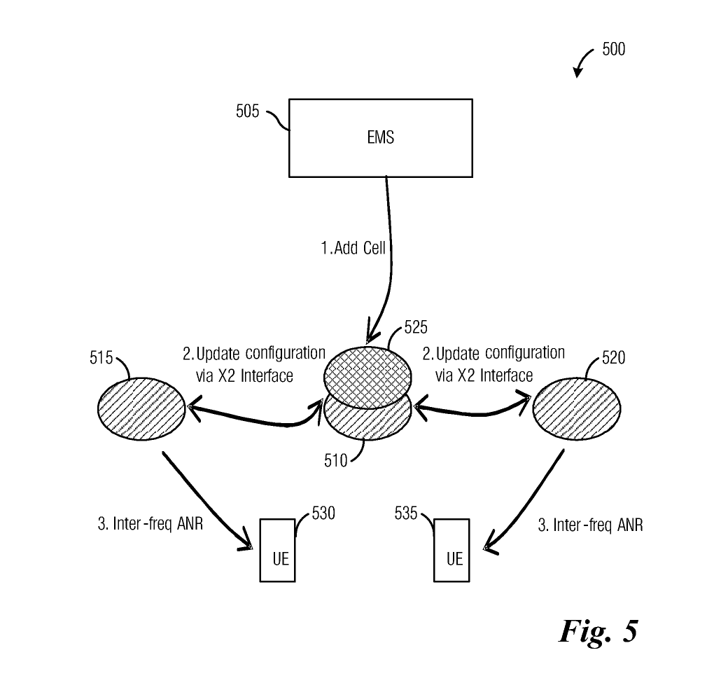

FIG. 5 illustrates a communications system 500, wherein a cell-based automatic carrier growth detection technique for inter-frequency ANR is used. Communications system 500 includes an EMS 505 that may include systems and applications that may be used to manage network elements of communications system 500. EMS 505 may be used to manage eNBs, such as eNBs 510, 515, and 520. Communications system 500 also includes UE, such as UE 530, and 535. The eNBs may serve the UEs by scheduling transmissions to and from the UEs using available network resources.

As shown in FIG. 5, a supported capacity of eNB 510 may be reached (or exceeded) and to provide acceptable performance, additional carrier(s) (such as carrier 525) may be added to eNB 510 (i.e., center cell). As the new carrier(s) is added to eNB 510, a cell-based automatic carrier growth detection technique may be used to propagate information regarding the new carrier(s). The cell-based automatic carrier growth detection technique may rely on control plane signaling between eNBs in communications system 500 using an X2 standardized interface. The cell-based automatic carrier growth detection technique may include the following operations:

1. When a new carrier is added to eNB 510, eNB 510 may send a “eNB configuration update” message to neighboring eNBs (cells) via the X2 interface. The “eNB configuration update” message may be defined in 3GPP TS36.423, which is incorporated herein by reference. Some operations to select the number of neighboring eNBs to send the “eNB configuration update” message may be performed to optimize the number of neighboring eNBs involved due to the new carrier addition. The selection of neighboring eNBs by eNB 510 may utilize one or more of the neighbor cell determination techniques described previously.

2. The use of the “eNB configuration update” message may allow eNB 510 to synchronize the new carrier's information to the neighboring eNBs.

3. The neighboring cells may start to order UEs that they are serving to scan the frequency of the new carrier and add to the inter-frequency neighbor cell list via the inter-frequency ANR procedure.

Although the discussion of the above described cell-based automatic carrier growth detection technique focuses on adding carriers, the cell-based automatic carrier growth detection technique may also be applied to removing carriers. The cell-based automatic carrier growth detection technique described above may be used in both situations (carrier growth and carrier reduction). Therefore, the discussion of carrier growth should not be construed as being limiting to either the scope or the spirit of the embodiments.

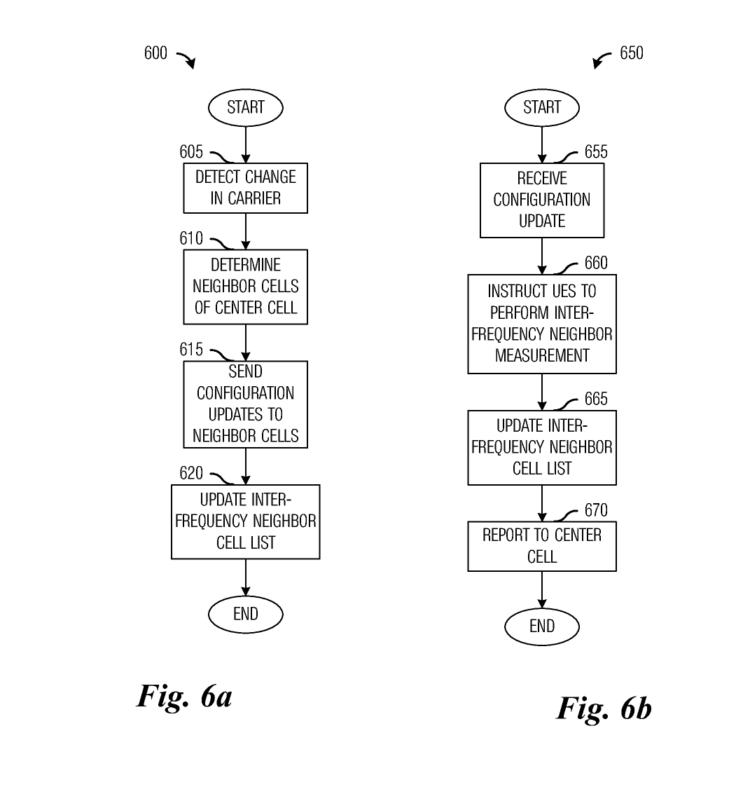

FIG. 6a illustrates a flow diagram of center cell operations 600 in a cell-based automatic carrier growth detection technique. Center cell operations 600 may be indicative of operations occurring in a center cell of a communications system as the center cell participates in the cell-based automatic carrier growth detection technique discussed previously. Center cell operations 600 may occur whenever a carrier(s) is added to or removed from the center cell. Center cell operations 600 may occur while the center cell is in a normal operating mode.

Center cell operations 600 may begin with the center cell detecting that a carrier(s) has been added to or removed by an EMS controlling the center cell (block 605). As discussed previously, an operator may manually or automatically change the carrier deployment of the center cell by using the EMS. In addition to changing the carrier deployment of the center cell, the EMS may generate a configuration update that it may provide to the center cell.

After detecting the carrier change, the center cell may determine its intra-frequency neighbor cells (of the newly added carrier in the situation wherein the carrier change comprises the addition of one or more carrier(s)) and send the configuration update to the intra-frequency neighbor cells (block 610). According to an embodiment, the center cell may have access to information about itself and other cells operating in the communications system that may be stored in the EMS and made available to the center cell by the EMS. Examples of the information may include geo-location information, antenna configuration (such as antenna azimuth angle, tilt, array configuration, and so forth), and so on. The center cell may request the information from the EMS and may use a variety of techniques to determine the intra-frequency neighbor cells.

According to an embodiment, the center cell may determine the intra-frequency neighbor cells (of the newly added carrier in the situation wherein the carrier change comprises the addition of one or more carrier(s)) based on its NRT if the NRT is stable, i.e., if the ANR function has been active for some time and contents of the neighbor list is stable. In other words, the center cell may infer the intra-frequency neighbors from the stable NRT.

According to another embodiment, the center cell may use geo-location calculation(s) to determine a potential list of intra-frequency neighbor cells. For example, the center cell may use its latitude and longitude information along with its antenna bearing and a distance factor to compute the potential list of intra-frequency neighbor cells. For example, the center cell may select cells that are less than a distance range away as intra-frequency neighbor cells.

According to yet another embodiment, the center cell may select cells that are within a specified distance away as intra-frequency neighbor cells, where the specified distance may be determined based on its cell morphology, radio frequency (RF) propagation characteristics, operating frequency, field test measurements, and so forth.

After determining the intra-frequency neighbor cells, the center cell may send the configuration update to the intra-frequency neighbor cells (block 615). According to an embodiment, the center cell may send the configuration update to the intra-frequency neighbor cells using X2 application protocol (AP) signaling. X2 AP is a standardized signaling protocol between peer-to-peer eNB in the 3GPP LTE technical standards. After sending the configuration update to the intra-frequency neighbor cells, the center cell may update its own inter-frequency neighbor list based on reports from the intra-frequency neighbor cell (block 620). Alternatively, the center cell may update its own inter-frequency neighbor list based on X2 control signaling containing UE history information that is sent as part of handover signaling. Center cell operations 600 may then terminate.

FIG. 6b illustrates a flow diagram of neighbor cell operations 650 in a cell-based automatic carrier growth detection technique. Neighbor cell operations 650 may be indicative of operations occurring in a cell that is a neighbor (i.e., a neighbor cell) to a center cell that has had a change (increase or decrease) in its carrier deployment as the neighbor cell participates in the cell-based automatic carrier growth detection technique discussed previously. Neighbor cell operations 650 may occur while the neighbor cell is in a normal operating mode.

Neighbor cell operations 650 may begin with the neighbor cell receiving a configuration update from the center cell (block 655). According to an embodiment, the configuration update may be sent by the center cell to cells that have been determined to be intra-frequency neighboring cells of the center cell. For example, the center cell may determine intra-frequency neighboring cells based on an NRT, geo-location calculations, cells within a specified distance from the center cell, or so on. The configuration update may be transmitted to the intra-frequency neighbor cells using layer three messages, such as RRC messages.

The neighbor cell may instruct UEs that it is serving to perform inter-frequency neighbor measurements (block 660). According to an embodiment, the neighbor cell may configure measurement command measurements to be sent over an air-interface to the UEs to instruct the UEs that it is serving to scan the new carrier if the cell has added additional carrier(s). Results of the measurements performed by the UEs may be provided back to the neighbor cell where the results may be used by the neighbor cell to update its neighbor list, e.g., adding inter-frequency neighbor cells, and so on.

As part of the inter-frequency ANR procedures, the neighbor cell may receive reports back from the UEs and the neighbor cell may make use of the reports from the UEs to update its inter-frequency neighbor cell list (block 665). Depending on communications system, the neighbor cell may provide a copy of its inter-frequency neighbor cell list (along with other neighbor cell lists) to its UEs. Furthermore, the neighbor cell may provide a report to the center cell (block 670). The report may include a copy of its inter-frequency neighbor cell list. Neighbor cell operations 650 may then terminate.

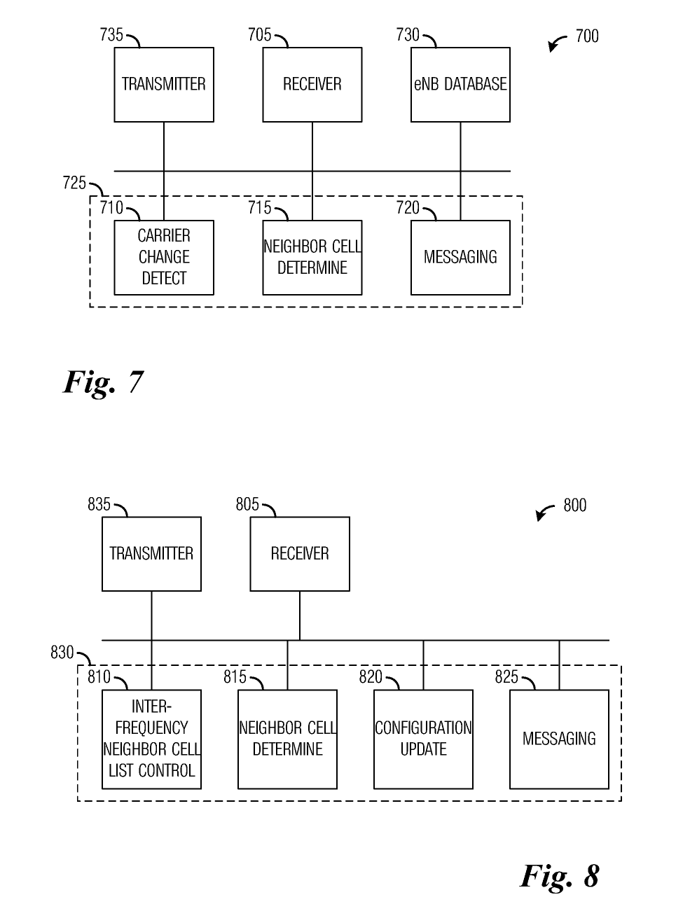

FIG. 7 provides an alternate illustration of an EMS 700. EMS 700 may be used to implement various ones of the embodiments discussed herein. As shown in FIG. 7, a receiver 705 is configured to receive information. A carrier change detect unit 710 is configured to detect a change in carrier deployment of a cell or eNB. For example, carrier change detect unit 710 may detect operator input to remove or add a carrier for a cell or the execution of a script to automatically remove or add a carrier.

A neighbor cell determine unit 715 is configured to determine neighbor cells, such as intra-frequency neighbor cells or inter-frequency neighbor cells, of a cell that has undergone carrier change. Neighbor cell determine unit 715 may utilize a neighbor cell determination technique as described previously. A messaging unit 720 is configured to generate messages for information to be transmitted and/or extract information from received messages. An eNB database 730 may store information regarding cells, such as geo-location information, antenna configuration (such as antenna azimuth angle, tilt, array configuration, and so forth), and so on. A transmitter 735 is configured to transmit information.

The elements of EMS 700 may be implemented as specific hardware logic blocks. In an alternative, the elements of EMS 700 may be implemented as software executing in a processor, controller, application specific integrated circuit, or so on. In yet another alternative, the elements of EMS 700 may be implemented as a combination of software and/or hardware.

As an example, receiver 705 and transmitter 735 may be implemented as specific hardware blocks, while carrier change detect unit 710, neighbor cell determine unit 715, and messaging unit 720 may be software modules executing in a processor 725 or custom compiled logic arrays of a field programmable logic array. eNB database 730 may be part of a memory in EMS 700.

FIG. 8 provides an alternate illustration of a cell 800. Cell 800 may be used to implement various ones of the embodiments discussed herein. As shown in FIG. 8, a receiver 805 is configured to receive information. An inter-frequency neighbor cell list control unit 810 is configured to maintain an inter-frequency neighbor cell list based on reports of measurements made by UE served by cell 800.

A neighbor cell determine unit 815 is configured to determine neighbor cells, such as intra-frequency neighbor cells or inter-frequency neighbor cells, of a cell that has undergone carrier change. Neighbor cell determine unit 815 may utilize a neighbor cell determination technique as described previously. Neighbor cell determine unit 815 may make use of information related to cell 800 as well as other cells provided by an EMS controlling cell 800. A configuration update unit 820 is configured to update configuration information of cell 800 based on changes in carrier deployment, reports from UEs, and so forth. A messaging unit 825 is configured to generate messages for information to be transmitted and/or extract information from received messages. A transmitter 835 is configured to transmit information.

The elements of cell 800 may be implemented as specific hardware logic blocks. In an alternative, the elements of cell 800 may be implemented as software executing in a processor, controller, application specific integrated circuit, or so on. In yet another alternative, the elements of cell 800 may be implemented as a combination of software and/or hardware.

As an example, receiver 805 and transmitter 830 may be implemented as specific hardware blocks, while inter-frequency neighbor cell list control unit 810, neighbor cell determine unit 815, configuration update unit 820, and messaging unit 825 may be software modules executing in a processor 830 or custom compiled logic arrays of a field programmable logic array.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for centralized carrier change detection, the method comprising:
detecting a carrier change in a carrier deployment of a cell;
determining at least one inter-frequency neighbor cell of the cell; and
updating the at least one inter-frequency neighbor cell regarding the carrier change.

2. The method of claim 1, wherein the carrier change comprises an addition of at least one carrier in the carrier deployment in the cell or a removal of at least one carrier in the carrier deployment in the cell.

3. The method of claim 1, wherein detecting a carrier change comprises detecting an operator changing the carrier deployment.

4. The method of claim 1, wherein detecting a carrier change comprises detecting an execution of a script to change the carrier deployment.

5. The method of claim 1, wherein determining at least one inter-frequency neighbor cell comprises using an intra-frequency neighbor relationship table of the cell.

6. The method of claim 5, wherein the intra-frequency neighbor relationship table is used only if the intra-frequency neighbor relationship table is stable.

7. The method of claim 1, wherein determining at least one inter-frequency neighbor cell comprises using a geo-location calculation to determine the at least one inter-frequency neighbor cell.

8. The method of claim 7, wherein the geo-location calculation makes use of a position of the cell, an antenna bearing of the cell, a distance factor for the cell, an operating frequency or operating frequencies of carriers in the carrier deployment, or a combination thereof.

9. The method of claim 8, wherein the carrier deployment of the cell comprises a first carrier with a first operating frequency and a second carrier with a second operating frequency, wherein the second carrier is a carrier added to the carrier deployment of the cell, wherein a difference between the first operating frequency and the second operating frequency is less than a threshold, and wherein the at least one inter-frequency neighbor cell comprises at least one intra-frequency neighbor cell of the first carrier.

10. The method of claim 1, wherein determining at least one inter-frequency neighbor cell comprises selecting cells that are within a specified distance from the cell as the at least one inter-frequency neighbor cell.

11. The method of claim 10, wherein the specified distance is based on a cell morphology of the cell, radio frequency propagation characteristics, operating frequency, field test measurements, or a combination thereof.

12. The method of claim 1, wherein updating the at least one inter-frequency neighbor cell comprises sending a configuration update to the at least one inter-frequency neighbor cell.

13. The method of claim 12, wherein the configuration update is sent using operations, administration, and management (OAM) signaling, X2 control signaling messages, or combination thereof.

14. A method for communications controller operation, the method comprising:
receiving an update regarding a change in a carrier deployment of a cell;
instructing a served communications device to perform an inter-frequency neighbor measurement; and
updating an inter-frequency neighbor cell list.

15. The method of claim 14, further comprising receiving a report from the served communications device.

16. The method of claim 15, wherein updating an inter-frequency neighbor list comprises updating the inter-frequency neighbor cell list based on the report.

17. The method of claim 14, wherein instructing a served communications device comprises sending a configure measurement command message to the served communications device.

18. The method of claim 17, wherein the configure measurement command message comprises a radio resource control message.

19. The method of claim 14, wherein the update comprises a configuration update.

20. The method of claim 19, wherein the configuration update is sent by a manager of the cell.

21. The method of claim 19, wherein the configuration update is sent by the cell.

22. The method of claim 14, further comprising causing to occur, an update of an inter-frequency neighbor cell list at the cell.

23. A method for carrier change detection in a cell, the method comprising:
detecting a carrier change in a carrier deployment of the cell;
determining at least one intra-frequency neighbor cell of the cell; and
updating the at least one intra-frequency neighbor cell regarding the carrier change.

24. The method of claim 23, wherein detecting a carrier change comprises detecting an addition of at least one carrier in the carrier deployment or a removal of at least one carrier in the carrier deployment.

25. The method of claim 23, wherein determining at least one intra-frequency neighbor cell is based on information from a manager of the cell.

26. The method of claim 25, wherein determining at least one intra-frequency neighbor cell comprises:
requesting information from the manager; and
determining the at least one intra-frequency neighbor cell based on the information.

27. The method of claim 26, wherein the information comprises geo-location information for the cell, and wherein determining the at least one intra-frequency neighbor cell based on the information comprises using a geo-location calculation to determine the at least one intra-frequency neighbor cell.

28. The method of claim 26, wherein the information comprises geo-location information for the cell, and wherein determining the at least one intra-frequency neighbor cell based on the information comprises selecting cells that are within a specified distance from the cell as the at least one intra-frequency neighbor cell.

29. The method of claim 23, wherein determining at least one intra-frequency neighbor cell comprises using an intra-frequency neighbor relationship table of the cell.

30. The method of claim 23, wherein updating the at least one intra-frequency neighbor cell comprises sending a configuration update to the at least one intra-frequency neighbor cell.

31. The method of claim 23, further comprising:
receiving updates of inter-frequency neighbor cell lists from the at least one intra-frequency neighbor cell; and
updating an inter-frequency neighbor cell list based on the updates from the at least one intra-frequency neighbor cell.

32. A network entity comprising:
a carrier change detect unit configured to detect a change in a carrier deployment of a cell managed by the manager;
an inter-frequency neighbor cell determine unit coupled to the carrier change detect unit, the inter-frequency neighbor cell determine unit configured to determine inter-frequency neighbor cells of the cell;
a messaging unit coupled to the carrier change detect unit and to the inter-frequency neighbor cell determine unit, the messaging unit configured to generate an update message; and
a transmitter coupled to the messaging unit, the transmitter configured to send the update message.

33. The network entity of claim 32, wherein the carrier change detect unit is configured to detect an operator changing the carrier deployment or an execution of a script to change the carrier deployment.

34. The network entity of claim 32, wherein the inter-frequency neighbor cell determine unit is configured to use an intra-frequency neighbor relationship table of the cell, a geo-location calculation, select cells within a specified distance from the cell, or a combination thereof, to determine the inter-frequency neighbor cells.
